(19) United States
(12) Patent Application Publication
(10) Pub. No.: US 2016/0020844 A1
(43) Pub. Date: Jan. 21, 2016

(54) SYSTEMS AND METHODS FOR WIRELESS BACKHAUL TRANSPORT

(71) Applicant: GOOGLE INC., Mountain View, CA (US)

(72) Inventors: Mike Hart, Seattle, WA (US); Pete Gelbman, Bothell, WA (US)

(21) Appl. No.: 14/774,030

(22) PCT Filed: Mar. 14, 2014
(86) PCT No.: PCT/US14/29742

§ 371 Date: Sep. 9, 2015

Related U.S. Application Data
(60) Provisional application No. 61/784,788, filed on Mar. 14, 2013.

(51) Int. Cl. H04B 7/06; H04L 5/14; H04L 29/02; H04W 72/04

(52) U.S. Cl. CPC H04B 7/0617; H04W 72/04; H04L 5/14; H04L 29/02; H04W 84/18

(57) ABSTRACT

Systems and methods are described for providing wireless backhaul transport. One element of the system is a highly integrated radio transceiver, including an integrated antenna. The radio transceiver may operate in the millimeter wave range (between 30 GHz and 300 GHz), and due to the small wavelengths, it is possible to integrate the antenna, which would typically compromise a number of antenna elements, with the radio transceiver in a single integrated circuit (IC) package, commonly referred to as a system-in-package (SiP) and/or antenna-in-package (AiP) format. In some implementations, the band that a hardware module can exploit is the unlicensed 60 GHz band, which is generally available globally.

### CROSS-REFERENCE TO RELATED APPLICATION(S)

The present application claims priority to and the benefit of U.S. Provisional Patent Application No. 61/784,788, filed Mar. 14, 2013, entitled “SYSTEMS AND METHODS FOR WIRELESS BACKHAUL TRANSPORT.” The disclosure of the above-listed application is hereby incorporated by reference in its entirety.

### BACKGROUND

Mobile data traffic growth is exploding, and is projected by Cisco to continue to grow at a global CAGR of 78% until at least 2016. Similarly, traffic on fixed access networks is also growing aggressively, driven by new bandwidth intensive, video rich, applications & services, and the trend towards centralization of services into “the cloud” and the “big data” era.

Both wireless and fixed access networks will have to dramatically scale their ability to provide high capacity transport in the core as well high data rates to the end users in order to not only meet this demand but to be able to provide it in a much more cost/GB efficient manner.

Wireless access networks are transitioning from the old coverage centric design methodology to one of cost-effective provision of capacity. This means smaller, more efficient “cells”, providing targeted capacity where it is needed using whatever access technology and spectrum is available, including WiFi in unlicensed spectrum bands, HSPA and LTE in licensed spectrum bands, and LTE advanced and future generations of “5G” in both licensed, “lightly-licensed” and unlicensed bands. While technology exists to enable these “small cells” to be manufactured, supporting one or more of the family of “4G” technologies and spectrum bands, a challenge is in similarly cost-effectively scaling the backhaul network to connect potentially thousands of these access nodes across a metropolitan area into the core network.

Wired access networks are also being evolved, pushing fiber closer to the edge, and upgrading transport in the core from 10G to 40G to 100 Gbps. In some countries and regions fiber to the home/premises (FTTH/P) has been aggressively deployed. In others, especially where local regulations require buried distribution networks, the cost is too prohibitive, and instead fiber to the curb/node (FTTC/N) is pursued, using enhanced DSL or other copper based technologies, such as copper based Ethernet, to provide the last leg of the connection into the home or business premise. While using advanced DSL technologies over pre-installed copper telephone lines enables fast Ethernet services to the home (˜100 Mbps), it is questionable how far buried copper based networks can continue to scale. Hence, a challenge is in cost-effectively scaling the last leg of the distribution network to provide FTTH like services without the huge expense associated with laying fiber to every potential subscriber.

While there is a role for “wired” transport technologies to play in both cases outlined above, predominantly in the form of fiber, in a large number of cases the use would be cost-prohibitive. This may occur in the case that the location at which the connection is required is not readily served by an existing fiber run and would therefore require a special installation and expenditure that pushes the cost per GB transported beyond the market rate. It is worth noting that the cost-economics of fiber generally work when a fiber is well utilized; therefore, runs are installed to nodes that have high utilization, or a run is typically shared with multiple end users (i.e. GPON FTTH).

The need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIG. 1 is a block diagram of a module for providing wireless backhaul transport.

FIG. 2 is a diagram showing a deployment of nodes that contain modules within a city block for providing wireless backhaul transport.

FIGS. 3A-3C are diagrams showing how modules can be implemented and used to form various types of nodes for providing wireless backhaul transport.

FIGS. 3D-3F and 3H-3K are diagrams showing elements incorporated into different implementations of the modules of FIGS. 3A-3C.

FIG. 3G is a diagram showing an example of an RF SiP architecture.

FIG. 4 is a diagram describing some benefits of using multi-hop communication for providing a wireless backhaul transport.

FIG. 5 is a diagram showing medium access control (MAC) layer data plane architecture and its key functions.

FIG. 6 is a diagram showing physical (PHY) and radio frequency (RF) architecture.

### DETAILED DESCRIPTION

### Overview

In the cases where fiber is prohibitively expensive, there is a role for wireless technologies. However, there is a lack of a solution that can meet all of the current requirements that also has a roadmap to continue to scale with the expected demand. Some features for a solution can be summarized as:
Ability to provide low latency, minimum FE like speeds to nodes/users, scaling to gigabit over Ethernet (GbE) like speeds and beyond
Simple to deploy and install—no complex planning, engineering or installation practices required; enables transport of data to/from multiple access nodes and a single fiber PoP in a metropolitan area (metro-zone)
Low cost capital expenditures and operating expenses (CAPEX & OPEX)
Simple to operate and maintain—self organization and adaptive to changes in network topology
   Some existing technologies may address one of these features, but no current technology addresses all.

Systems, modules, hardware, and software are described herein that provide wireless backhaul transport. The following description meets the aforementioned features for a transport solution as well as providing other advantages. One element of the system is a highly integrated radio transceiver, including an integrated antenna. The radio transceiver may operate in the millimeter wave range (between 30 GHz and 300 GHz), and due to the small wavelengths, it is possible to integrate the antenna, which would typically compromise a number of antenna elements, with the radio transceiver in a single integrated circuit (IC) package, commonly referred to as a system-in-package (SiP) and/or antenna-in-package (AiP) format. One band that a hardware module can exploit is the unlicensed 60 GHz band, which is generally available globally. However, as new bands become available above 100 GHz, additional embodiments and implementations may exploit different frequency ranges, for example a band at 120 GHz or 240 GHz.

Various examples of the invention will now be described. The following description provides certain specific details for a thorough understanding and enabling description of these examples. One skilled in the relevant technology will understand, however, that the invention may be practiced without many of these details. Likewise, one skilled in the relevant technology will also understand that the invention may include many other obvious features not described in detail herein. Additionally, some well-known structures or functions may not be shown or described in detail below, to avoid unnecessarily obscuring the relevant descriptions of the various examples.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

System Description

As noted above, the radio transceiver under an aspect of the invention includes an integrated antenna, in a SiP, including an AiP, format. The antenna may be configured to allow the focusing of the energy associated with a transmission in a particular direction (beam direction), such as to improve the resilience of the link in the form of an overall increase in the signal to noise plus interference ratio.

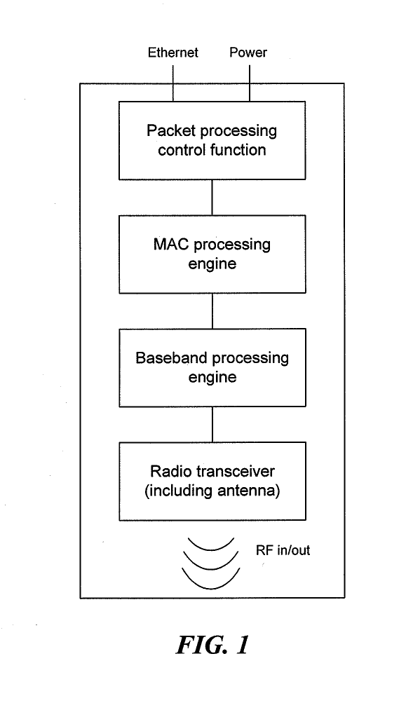

FIG. 1 depicts the overall architecture of a wireless communication transceiver module that converts Ethernet frames to a beamformed radio signal, such as a 60 GHz beamformed radio signal, and a beamformed radio signal to Ethernet frames. The wireless communication transceiver module includes a layer-2 packet processing function (PPF), which may incorporate a bridging or switching function, a MAC processing engine, a baseband processing engine, and a radio transceiver. On the transmit side, the module receives Ethernet frames from the host node in which it is embedded, or from another module or host node to which it is connected. In addition the power for the module may be supplied using power over Ethernet or an alternative source in the case that power over Ethernet is not supported by the host node. The PPF translates Ethernet frames to the frame format used at the MAC sub-layer. In addition, the PPF may buffer frames and perform quality of service (QoS) queuing/dequeuing functions, may apply frame filtering, and may perform frame header operations such as manipulating marking or tags of specific frames. The MAC processing engine controls access to the physical wireless medium, which may be either a point-to-point (1 to 1) or point-to-multi-point (1 to many) communication channel. The baseband processing engine provides physical layer functionality, converting MAC frames into a baseband signal. The baseband processing engine also controls the mode of operation of the radio transceiver, which includes at least one antenna and a radio frequency integrated circuit (RFIC). Typically, the baseband processing engine converts the transmitted signal into an analog signal that is provided to the RFIC. In addition, it controls the operation of the RFIC over a digital interface. In particular, the baseband processing engine configures the transmit antenna settings so that they are appropriate for each frame transmitted. The reverse operation is supported on the receive side. Further details regarding elements of the wireless communication transceiver module are provided herein.

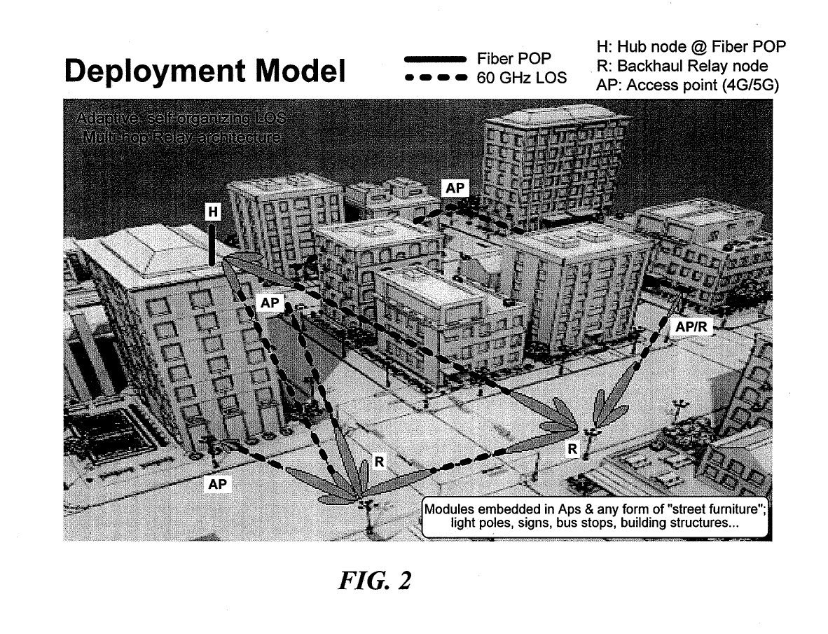

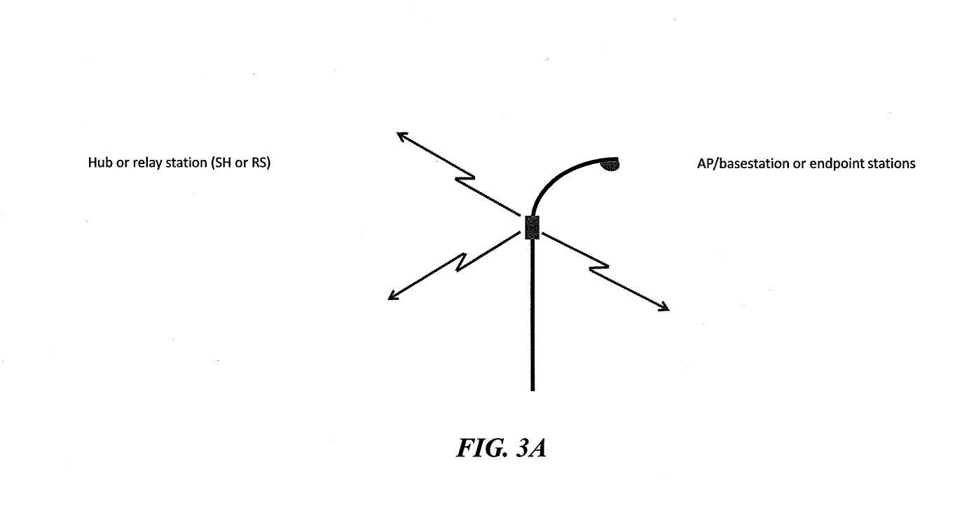

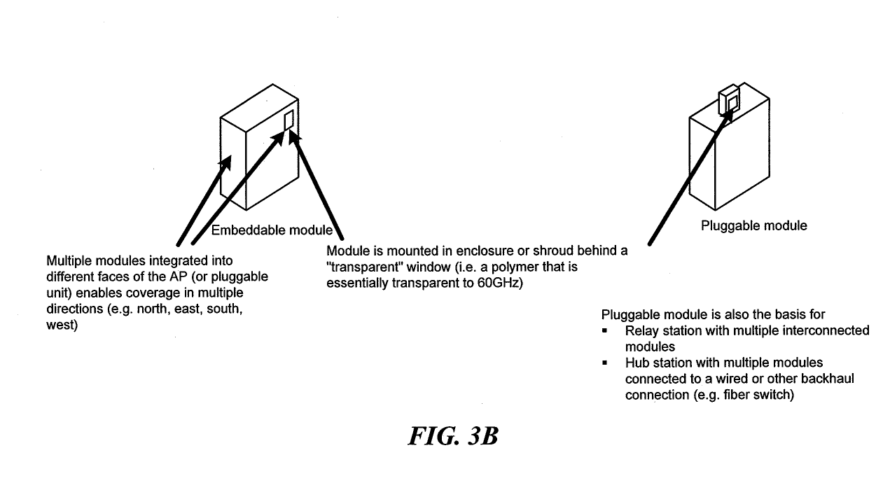

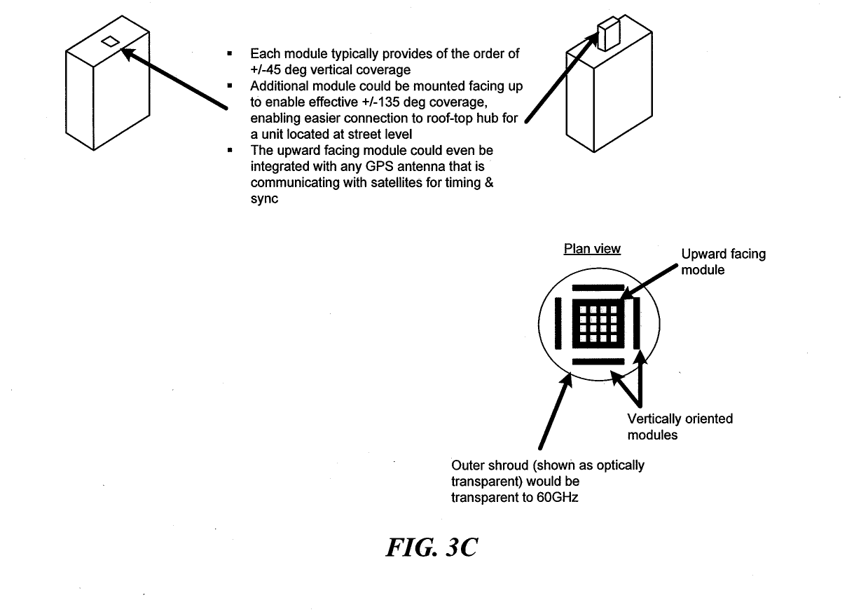

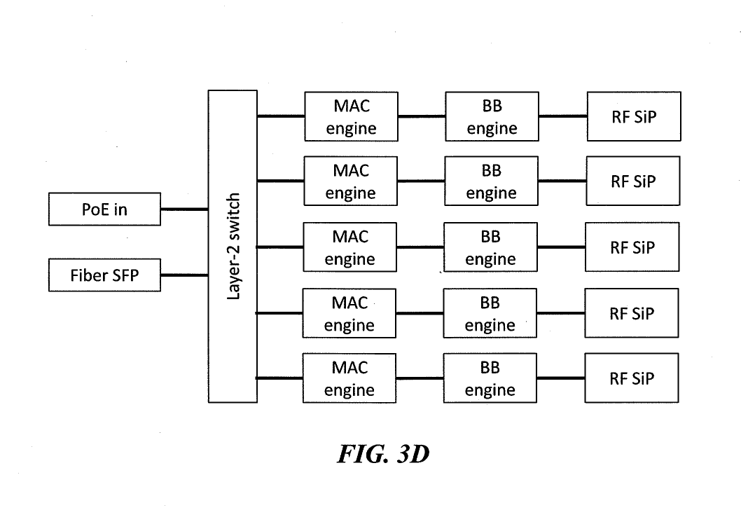

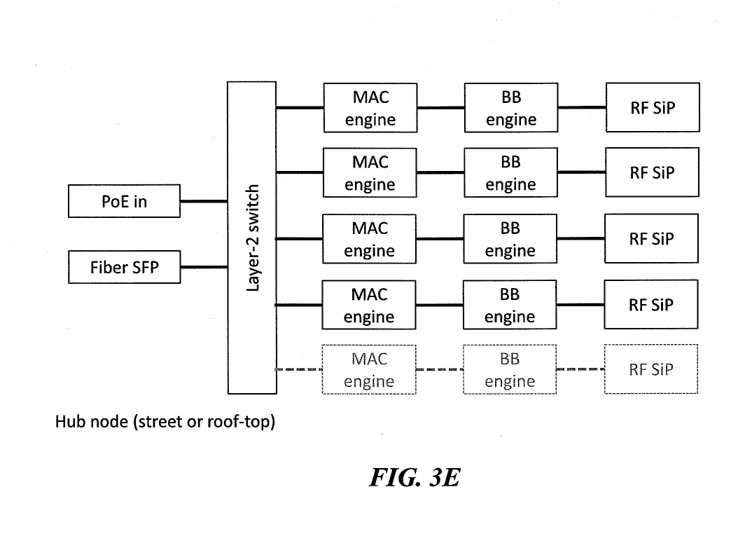

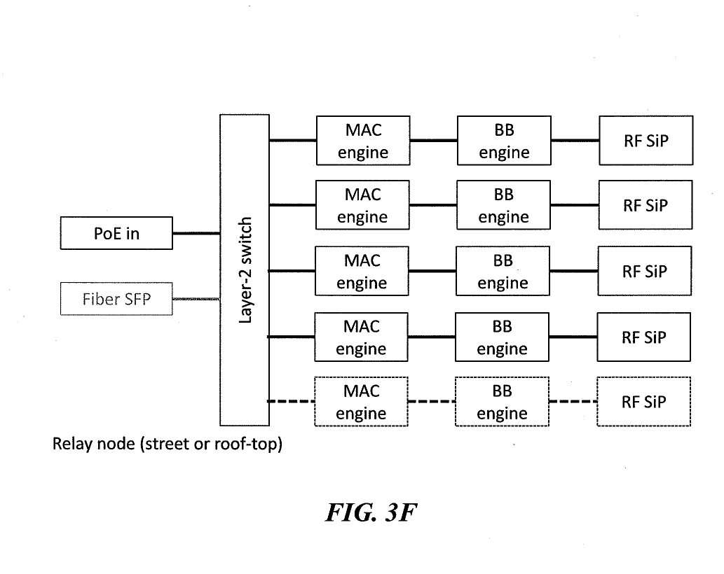

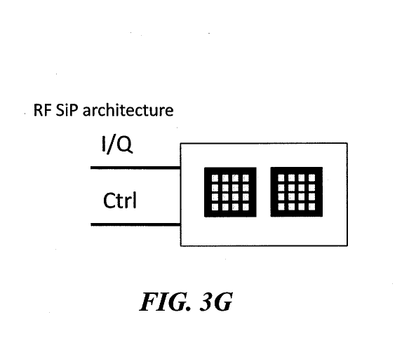

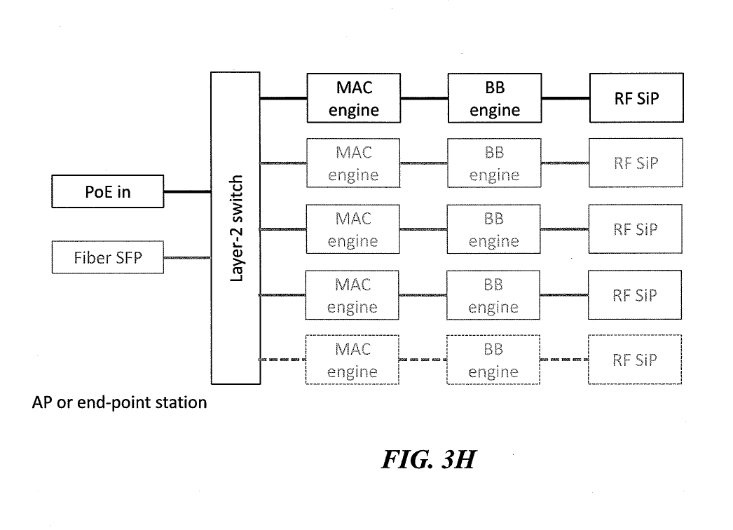

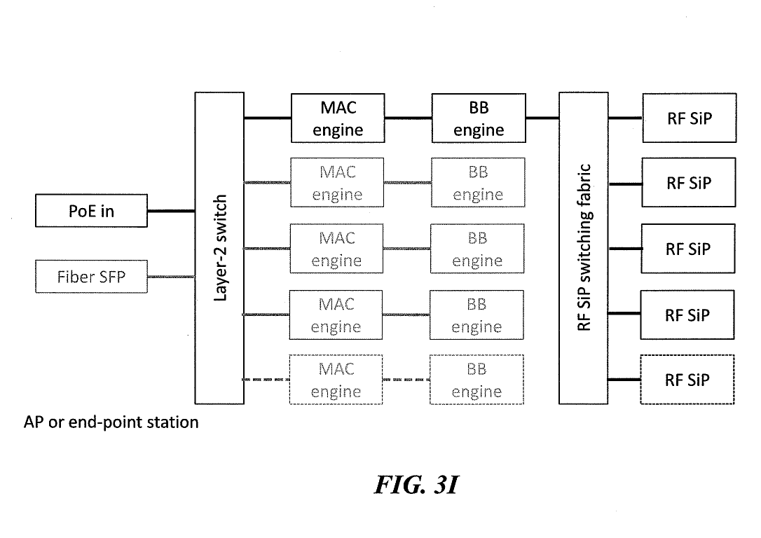

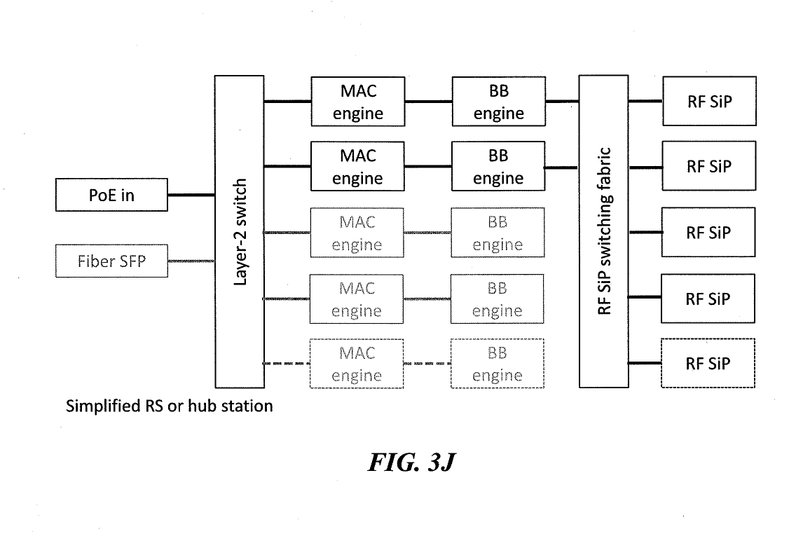

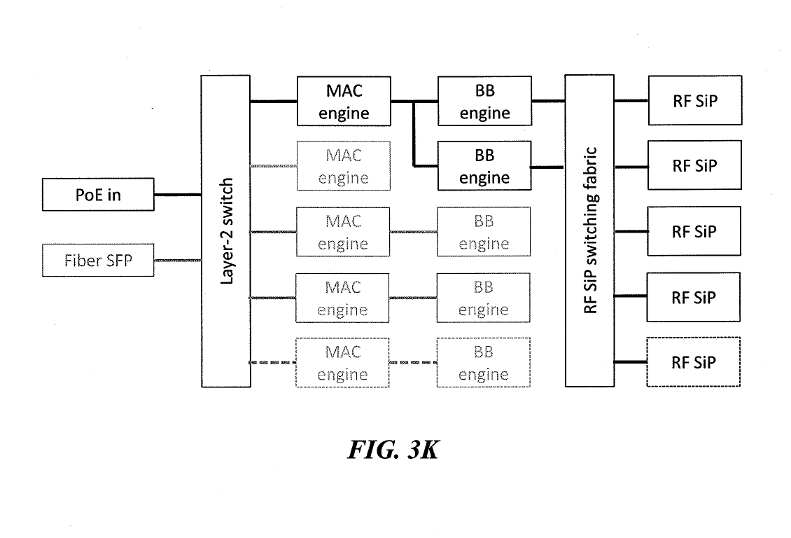

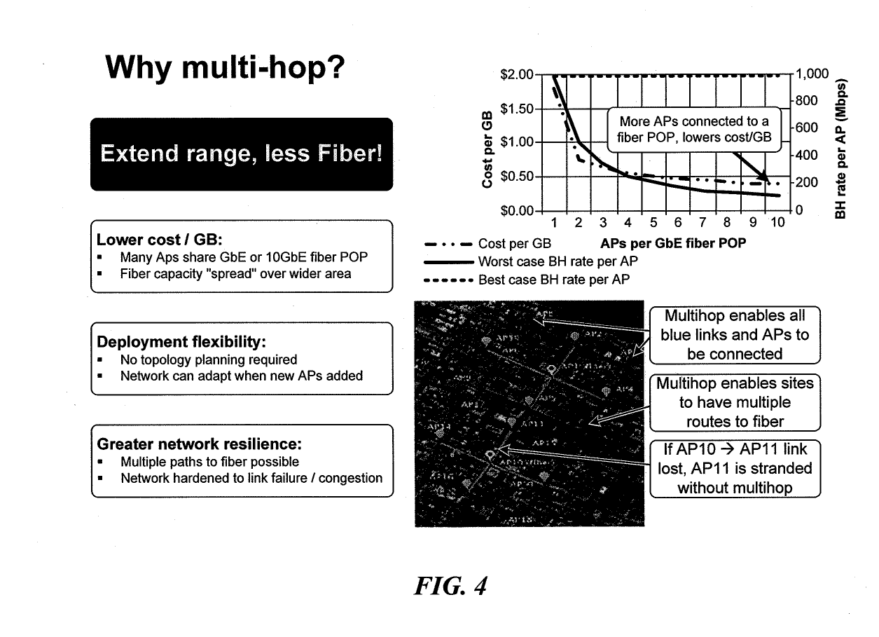

FIG. 2 depicts the different ways in which different node types containing one or more hardware modules are used to provide the overall solution to the problem. FIGS. 3A-J depict how modules may be integrated to form different node types, including specific details of the operation of the modules to provide relaying functionality within a multi-hop point-to-multi-point or multi-hop mesh network. FIG. 4 shows some benefits of using multi-hop communication in either a point-to-multi-point or mesh topology for providing a wireless backhaul transport.

FIG. 3A shows an example of one or more of the wireless communication transceiver modules of FIG. 1 incorporated into a wireless node, such as a hub or relay station (HS or RS), or as an access point (AP), base station or endpoint station. The node is shown mounted on a light pole that may be positioned, e.g., over a street. The node of FIG. 3A may include an integrated panel array antenna with ˜+/−60 deg steerable beam coverage in azimuth, and ˜+/−45 deg steerable beam coverage in elevation. The node may employ Power-over-Ethernet input, and produce 60 GHz beamformed output. (Note that each node may incorporate one or more wireless communication transceiver modules (“modules”), and at times the terms “node” and “modules” may be used interchangeably herein.)

As a hub or relay station in a multi-hop point-to-multi-point or multi-hop mesh network topology, the node may incorporate 2, 3 or 4 modules combined to provide up to complete 360 deg coverage (e.g. at intersection 4 radios cover north, east, south, west directions). For a hub, if each link is at 1 Gbps, then the hub provides up to 4 Gbps capacity. Hub is the point of connection to fiber, or other backhaul mechanism behind the 60 GHz multi-hop point-to-multi-point or multi-hop mesh network.

Furthermore, the hub or relay station may be a standalone unit that is mounted on to an existing structure (e.g. a light pole, face of a building, behind a sign, at a bus or train stop, etc), or it could itself be embedded within that structure. For example a light pole (as shown in FIG. 3A) could integrate 1 or more modules, and provide PoE to the module. The light pole with integrated module would then present an integrated interface port (e.g. Ethernet port) such that any node that required a connection to a wider area network could be affixed to the light pole to not just gain power and a location to be mounted, but to also gain connectivity to a communication network. One such example of use of a “networked light pole” would be where a security camera could be mounted and connected to the Ethernet port on the pole. The “networked light pole” provides a physical mounting point, power and also connectivity of the security camera to a security network enabling the transmission of video frames to a centralized control center, and a means for a control center to control the camera. This example is intended to describe one such application that could be enabled by embedded modules into various types of “street-level furniture”, and there are many others that can be envisaged if the module is embedded into advertising signs, traffic signs, bus stops, train stops etc. In addition, not only do the pieces of street furniture gain the ability to provide access to a communication network to other units mounted on to them, but the modules embedded within them can connect together to form a multi-hop and/or mesh transport network to assist in connecting other “networked street-furniture” elements together.

As an AP, basestation or endpoint station, the node may incorporate a minimum of 1 wireless communication transceiver module integrated with into a non-hub or RS station. In this case only coarse alignment is needed—point in either north, east, south or west direction towards a hub or RS. Installation can be further simplified by increasing number of modules.

FIGS. 3B and 3C show use of one or more wireless communication transceiver (“modules”) integrated with the AP or other node, e.g. embedded inside the AP case or shroud surrounding the AP, and pluggable and connects to the AP in an integrated way (e.g. weatherized power-over-Ethernet connector).

One implementation shown in Plan view in FIG. 3C includes four vertically orientated modules, and one horizontal module as shown. This implementation includes a horizontal module that may incorporate GPS receive functionality. All 5 modules can be incorporated into a “dome” similar to that used for GPS receivers. The node may be backhaul capable pluggable unit that replaces the GPS dome typically installed on the top of access points, or can be added in addition in a similar manner.

Referring back to FIG. 1, the baseband processing engine is capable of generating wideband analog I/Q (in-phase and quadrature phase) signals for modulation to the radio frequency carrier by the radio transceiver, as well as configuring parameters associated with the radio transceiver that control the beam direction. The baseband engine is capable of taking digitized information signals on the order of Gbps and transposing them to an analog IQ signal of 1 GHz or greater bandwidth. In addition, the baseband engine may dynamically reduce available data rate in order to increase the system gain (e.g. by reducing the bandwidth used to reduce the noise in the system, or maintaining the wide bandwidth but increasing the coding overhead, thereby increasing the “processing gain”). Increasing the system gain equates to increasing the tolerable propagation loss between a transmitter and receiver, hence improving the robustness of a link enabling either an increase in range or resiliency to a link degrading event, such as rain, that causes an increase in the signal attenuation between a transmitter and receiver. From a protocol layer point of view, the “Physical layer” of the present system includes this baseband processing engine element. In some implementations, the interface between the first and second element is at baseband frequency (i.e. between the radio transceiver and the baseband processing engine). In other implementations, the interface is at some intermediate frequency, somewhere between the baseband (0 Hz) and RF frequency (e.g. 60 GHz). In addition, a control interface allows the baseband processing engine to control the properties of the radio transceiver, including parameters such as beam direction, antenna phase, transmit power, gain of amplifiers, polarization mode, etc. These first and second elements combined enable the transmission of digital signals over a wireless link in a certain direction.

Using the control interface, the baseband processing engine configures the antenna beam. In some implementations, the baseband processing engine configures the antenna beam by applying a set of phase shifts to each element in the array. Alternatively or additionally, the baseband processing engine configures the antenna beam by applying a complex number that contains both phase and amplitude (gain) adjustment for each element in the array. In another form, the baseband processing engine configures the antenna beam by turning array elements on and off, this could be, for example, windows in a waveguide structure, or could be controlling polarization used for a particular baseband signal. In its simplest form, the baseband processing engine identifies a beam identifier (ID) or antenna weight vector (AWV) ID or antenna element map (AEM) ID to be used at any point in time by the RFIC. The RFIC includes a mapping of ID to actual vector or element configuration to apply, where the vector or element configuration is determined and optimized during a beam training, refinement, and/or tracking phase. In some implementations, the baseband engine provides a full AWV or AEM to the RFIC, and the baseband engine maintains a list of AWVs/AEMs to use for each node that it is communicating with.

In this case, the AWV contains a set of phase and gain values where the size of the vector is equal to the number of elements in the antenna array, such that the baseband processing engine is able to control both the phase shift and any amplitude gain (or attenuation) of the signal supplied to each element in the array. Or if an AEM is used, then it contains a set of settings for each element (and possibly a set for each polarization of element) in the array (e.g. on/off), such that the baseband processing engine is able to control the effective spacing between elements in an array and/or the polarization used. Either of these approaches, and even a combination of them, allows the baseband processing engine to form various types of beam pattern and to steer both wanted energy in the desired direction, as well as to minimize the transmission of energy in the form of side-lobes, in an unwanted direction. Similarly, it allows the baseband processing engine to control where energy is received from on the receive side. It also enables a baseband engine to employ “multiple-input-multiple-output” techniques to transmit and receive simultaneously over more than one polarization to increase data rate and/or robustness. In the case where the RFIC supports simultaneous transmit and receive operations, then the baseband engine configures two sets of AWVs/AEMs to control the direction of both the transmit and receive array. In the case where the RFIC supports simultaneous transmit or receive on two different polarizations (e.g. vertical and horizontal MIMO), then there will be two AWVs/AEMs per RFIC.

The MAC processing engine controls the transmission of high layer protocol (e.g. Ethernet, IP, etc.) packets over one or more wireless links between nodes implementing the disclosed architecture. The MAC engine implements software that contains algorithms and methods to facilitate communication with multiple nodes using directional antennas. It also facilitates communication with nodes not within range of the wireless link, such as by using multi-hop point-to-multipoint or multi-hop mesh techniques to communicate via other nodes. The MAC processing engine is “beam aware” and intimately involved in the control of the configuration of the radio transceiver, through the baseband processing engine, to ensure frames and packets are transmitted and received with the appropriate antenna configuration. This is achieved by supplying an associated “beam configuration” to use when transmitting the frame with each MAC protocol data unit (MPDU) that is formed and sent to the baseband processing engine that hosts the physical layer functionality. As discussed earlier, the beam configuration could be a simple index to a beam ID to use, or could be a full AWV. In some implementations, the MAC engine enables the use of a baseband processing engine that is not “beam-aware.” For example, the MAC engine may interface directly to the RFIC such that it controls the RFIC and the baseband processing engine concurrently to ensure that the signal generated (or received) by the baseband engine is transmitted (or received) with the appropriate beam configuration. In such implementations the MAC engine can facilitate beam-forming training by configuring the baseband engine in a mode that supports this (e.g. low data rate, high processing gain) and then transitioning it to a “data-mode” (e.g. higher data rate, reduced processing gain) once training is complete. The MAC engine may generate control-frames and insert these into the data-path, e.g. in the form of specially addressed Ethernet frames, that the baseband is processing as well as control the PPF function to ensure that frames are only transferred to and from the baseband when it is operating in “data-mode”.

The MAC processing engine is also capable of supporting multi-hop point-to-multipoint or multi-hop mesh communications, or the transmission of a frame seamlessly over multiple, successive wireless links without the intervention of higher-layer protocols. It may achieve this by incorporating a layer-2 forwarding function within the MAC layer so that frame forwarding decisions can be made within the MAC layer itself, as the MAC layer is aware of the status of inbound and outbound physical links and beam settings. Incorporating a layer-2 forwarding function with the MAC layer enables rapid decision-making and optimal decisions to be made by the forwarding function that is both physical layer status and beam aware. One benefit of MAC layer relaying is that per link latency can be reduced compared to using higher-layer bridging. In addition, the utilization of the inbound and outbound physical layer link can be adjusted in harmony, resulting in more efficient transport of packets compared to where relaying was performed without context of the MAC and physical layer status. Referring to FIG. 3F, this allows a single module to provide both the “downstream” (e.g. to an access point) and “upstream” (e.g. to a hub station) relaying of frames simultaneously. In implementations in which relaying is provided at a higher layer, two modules would be required—one connected to the hub and one connected to the access point.

Referring to FIG. 3K, the MAC engine may also interface with multiple baseband engines, such that it is controlling more than one instance of the physical layer. In this case, the MAC engine is able to efficiently control the forwarding of frames over links controlled by the two baseband engines.

In general the operation and interaction between the wireless “beam-aware” MAC, baseband physical layer and RFIC enables the “beams” to become analogous to “ports” in a wired layer-2 Ethernet switch, with the wireless MAC layer managing the efficient forwarding of frames from one “port” (which is actually a “beam”) to another.

In addition, the functions of the MAC layer support auto discovery of other nodes and maintenance of wireless links found to other nodes without user intervention. The MAC layer also supports the configuration of appropriate frame and packet forwarding or configuration of tunnels to aid forwarding of frame and packets over multiple wireless links between the source and destination node in the wireless network. Auto discovery is supported by nodes that are established and operating in the network transmitting “beacons” or signals that identify their presence, such that nodes wishing to associate with the next node can learn of nodes to which they can gain access to the network. As the beamforming is used by the transmitter, this involves having nodes attached to the network “beam sweeping” the transmission of the beacon. This is achieved by transmitting the beacon multiple times, over a period of time, each time sending it to the baseband processing engine for transmission using a different beam ID (or AWV). The receiver typically listens for such transmissions using either a quasi-omnidirectional receive mode, or some form of coarse antenna beam to enable it to hear the beacon. As full optimal receive side beamforming is typically not available, the beacon is sent using very robust transmission approaches so that it can be received by a node that is not implementing high gain receive side beamforming. Once the beacon is received and the transmitter and receiver are essentially synchronized, then receiver side beamforming can take place to enable the transmitter and receiver to communicate using more spectrally efficient encoding schemes thereby achieving the target throughput rates.

The layer-2 PPF enables high layer packets sourced from, or destined to, a wireline network to be transported over the wireless link. At a minimum the PPF is responsible for translating Ethernet frames into wireless MAC frames. In the case there are no frames to be sourced from or supplied to the wireless network, the PPF may at a minimum act as a power source using power-over-Ethernet technologies. In the case of a node with multiple modules, then the PPF on one of the modules may provide a “master” function, which may include acting as a layer-2 bridge or switch. Referring to FIG. 3E, the PPF can be associated with one of the four modules shown. The other modules then connect to the first module, which provides the PPF between the fiber small form-factor pluggable (SFP) port, the master wireless module and the other 3 modules connected to it.

The system effectively converts Ethernet frames (and packets encapsulated within them, such as IP and/or MPLS) to mmWave transmission, and performs the reverse process for receiving frames and packets to/from multiple sources. The module is powered either separately or by using a shared Ethernet and power interface, commonly referred to as PoE (power-over-Ethernet).

Referring to FIG. 3D, general elements that comprise a module are shown, and in particular, FIG. 3D shows multiple modules that may be combined to provide the overall functionality required at a hub, relay station, access point or end-point station. FIG. 3E and other, similar Figures show alternative implementations with some unused elements from FIG. 3D shown grayed out. FIG. 3E shows a hub node that provides a backhaul to a wider area network through a fiber SFP port (or other appropriate interface, e.g. copper Ethernet). The node typically contains 2, 3 or 4 60 GHz modules to provide coverage in 2, 3 or 4 directions to achieve up to 360 deg coverage. Assuming 1 Gbps capacity per module, using a module per direction enables hub to provide 4 Gbps of backhaul capacity. The per module capacity can be upgraded over time, for example 2.5 Gbps/module utilizes a 10G fiber connection. Layer-2 PPF, including layer-2 switch or bridge functionality, may be provided by one module operating in “master” mode, with enough interfaces to support PoE in, fiber SFP (or other external network connection) and up to 3 other 60 GHz modules connecting to it. Alternatively or additionally, PPF functionality, including layer-2 switch or bridge functionality, may be provided by a separate module integrated into the AP or plugabble unit, along with the 60 GHz modules.

FIG. 3F shows a relay node which connects to a hub to provide connectivity to the WAN, where power is supplied over a PoE port. The relay node may include 1 or more modules, depending on total “field-of-view required”. One implementation can contain five modules: four to provide north, east, west, south coverage, and one to provide upward looking coverage to rooftop mounted nodes. The relay module can operate in half or full duplex mode, depending on configuration:
Full duplex relay with full duplex links: Module 1 can be communicating with an AP, while Module 2 is relaying frames to/from the hub;
Full duplex relay with half duplex links: Module 1 can be receiving from an AP while transmitting to the hub (or transmitting to the AP while receiving from the hub);
Half-duplex relay with full duplex links: Module 1 can be communicating with the AP at one point in time, then relaying frames to the hub at another point in time; and
Half duplex relay with half duplex links: Module 1 is either transmitting or receiving to/from the AP or node, alternating in time between direction and transceiver function.

FIG. 3H shows an AP or endpoint station, which connects to a hub/relay to provide connectivity to the WAN. The AP or endpoint station may include 1 or more modules, depending on total “field-of-view required”. One implementation can have one module that with the AP backhaul “window” or pluggable module roughly pointed in the direction of an RS or hub. PoE then provides the power as well as the port of connection to the host access point.

FIG. 3I shows another example of an AP or endpoint station, which includes multiple RF SiPs, but one MAC and baseband (BB) engine. The layer-2 PPF then allows the MAC and BB engine to be connected to any one RF SiP to enable communication in a given direction (e.g. either North, East, South, West, or even upwards). This example enables full field of view associated with a hub, but without the cost/complexity/power consumption associated with having to fully populate 4 or 5 full modules worth of components. The BB engine then controls the RF SiP switching fabric to ensure the appropriate RF SiP is configured for transmission or reception of any particular frame.

FIG. 3J shows a simplified RS or hub station. The RS or hub station can populate a full range of RF SiPs to provide wide area coverage without populating the same number of MAC & baseband (BB) engines to implement a reduced complexity RS or hub. For example, if a RS only ever needs to send data to one “superordinate” station and communicate with one “sub-ordinate” station at any one point in time, but needs full field of view coverage, then 2 MAC & BB engines can connect to the RF SiP switching fabric to enable flexibility in how the MAC engines connect to an RF SiP to send/receive frames in a given direction.

FIG. 3G shows an example of an RF SiP architecture, which contains either one or two antenna arrays comprised of multiple antenna elements. Each RF SiP may comprise one or more RFICs, and each RFIC may be capable of transmit, receive or both transmit and receive operation. Each array may comprise one or more sub-arrays of antenna elements with each sub-array driven by one transmit or receive chain of an RFIC. In the case multiple RFICs are used, and more than one RFIC is operating in transmit or receive mode at the same time on the same channel, then in order to for the two RFICs to effectively increase the gain of the array, then additional combining of signals is required either prior to or in the baseband engine, depending on whether the baseband engine is capable of interfacing to multiple RFICs. Alternatively the two or more RFICs that are operating in the same mode may be configured through software to work independently to form beams in different directions to enable simultaneous communication with more than one other node. As such, the “RF SiP” and “array” is a combination of multiple RFICs and/or sub-arrays of antenna elements that are packaged in a variety of ways to provide the integrated RF SiP. One such packaging approach is to include the RFIC silicon die(s) inside conventional integrated circuit package(s) (e.g. a ball grid array (BGA)) that are then mounted on to an appropriate substrate that contains the array elements. Alternatively the dies are directly bonded to the substrate. Overall the approach of using multiple RFICs in an RF SiP and sub-arrays in an array enables a practical trade-off between the number of transmit and/or receive chains (and hence components) per RFIC, the number of RFICs, and the number of elements per sub-array, which in effect enables a trade-off between overall cost, size, power consumption, beam width, steering range of the beam and performance.

As well as supporting half-duplex operation with time division duplexing, two arrays can support full duplex link operation, or full duplex relay/half-duplex link operation using frequency division duplexing. Full duplex link operation is achieved by a transmit (Tx) and receive (Rx) array pointing to the same node and allowing packets to be transmitted and sent at the same time. Frequency division full-duplex (FDD) operation is supported without the need for analog domain channel or sub-band filter, commonly referred to as a duplexer or diplexer, and typically required in any FDD communication system that has to share certain elements of the transmitter or receiver (e.g. antenna). Due to the high-level of integration proposed and the operating frequency, it is possible to ensure sufficient isolation between the transmitter and receiver components and antenna arrays to prevent the transmitted signal from interfering with the received signal in the analog domain. In light of this, transmitted signals may be filtered from received signals entirely in the digital domain.

Isolation between transmitter and receiver components is achieved in various ways. Isolation may be achieved by using separate transmit and receive antennas that are physically separated. At mmWave frequencies the separation does not need to be large due to the short wavelength. Isolation may also be achieved using beamforming to ensure that both the transmit and receive arrays are focused away from each other. Isolation may further be achieved by using robust modulation and coding schemes, which can be used due to the abundance of bandwidth, meaning that any residual leakage of energy after processing in the digital domain has minimal impact on receiver performance. For example, separation of a few centimeters provides at least 30 dB of isolation; in addition, with beamforming applied, the transmit and receive sidelobes can be ˜30 dB attenuated. The net result is a combined analog domain isolation of >90 dB which is of the order of that provided by a traditional duplexer. Further isolation could be provided by building low-profile “wall” (e.g. a sufficiently designed metallic, or other material, insulator) between the two arrays to reduce the effective coupling of signal between the two arrays. It is possible that as well as enabling improved operation (e.g. at higher order modulation and coding schemes, or reduced digital domain processing requirements) on adjacent frequencies, that with sufficient additional attenuation by a wall that isolations of >100 dB could be achieved enabling full duplex operation where the same channel is used for both transmit and receive.

Full duplex relay operation is achieved by the Tx array pointing to one node while the Rx array points to the other node; the Tx/Rx arrays then alternate over time to allow relaying of frames in both directions. This mode of operation can be particularly beneficial in networks with highly asymmetric traffic: e.g. downlink centric where data is generally flowing from hub to relay to AP to end-point. It also allows a module pointing in a coarse direction that needs to perform relay function to operate efficiently (e.g. hub and an AP are both North of the relay). Alternatively if only one array is available, or only one array can be active at any one point in time, then half-duplex operation can be supported.

In the general sense, due to the lack of an analog duplexer or diplexer, the frequency channel used for transmit and that used for receive can be defined in software, as well as whether the system is operating in full or half duplex, with frequency or time division duplexing, such that software-defined duplexing (SDD) is enabled.

FIG. 3K shows an example of a different type of module that has more than one baseband processing engine associated with a MAC engine. While FIG. 3K only shows two baseband processing engines associated with a single MAC engine, a further extension of this approach is to generally incorporate all MAC functionality for multiple baseband processing engines into one MAC engine. This enables the efficient forwarding of frames between wireless channels being managed by different baseband processing engines, as the MAC engine can directly forward frames from one baseband engine to the other without having to forward them through the layer-2 switch.

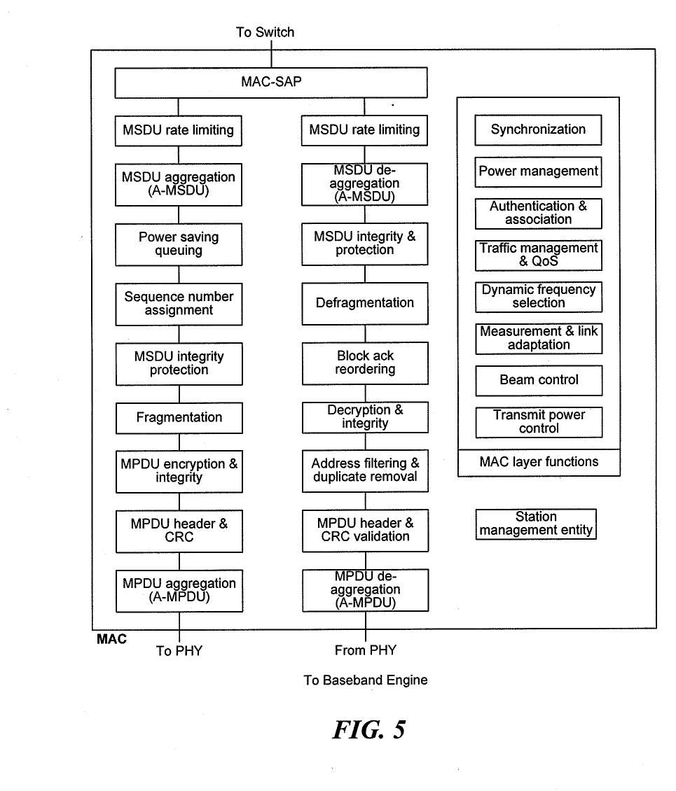

FIG. 5 shows the functional blocks of the MAC processing engine of FIG. 1, which is connected between the PPF and the baseband engine. The functional blocks of FIG. 5 are generally self-explanatory based on the detailed description provided herein. The MAC processing engine of FIG. 5 employs a MAC layer data plane architecture associated with a node implementing the IEEE 802.11 protocol, or similar. The data plane translates frames from the logical link control (LLC) layer entity to MPDUs for transfer to the physical layer (PHY) through the PHY-SAP, and performs similar reverse operations on the receive path. FIG. 5 also shows control and management plane functional blocks that may be included in a node. These functional blocks are responsible for controlling the data path operational behavior and the physical layer behavior, and they are also responsible for transmitting and receiving control and management frames to and from other stations to support functions such as enabling and maintaining access to the network.

Overall, the functional blocks shown in FIG. 5 are generally common among, e.g. APs, and the data-path is fixed, as per the standard (e.g. IEEE 802.11), as this is what enables a node from one vendor to send data packets to another. Specifics of some the algorithms behind the control plane functions can be implementation specific, such as beam control, link adaptation, and dynamic frequency selection. In addition, the MAC processing engine may employ MAC-layer forwarding of MPDUs as noted here for multi-hop point-to-multipoint relay functionality.

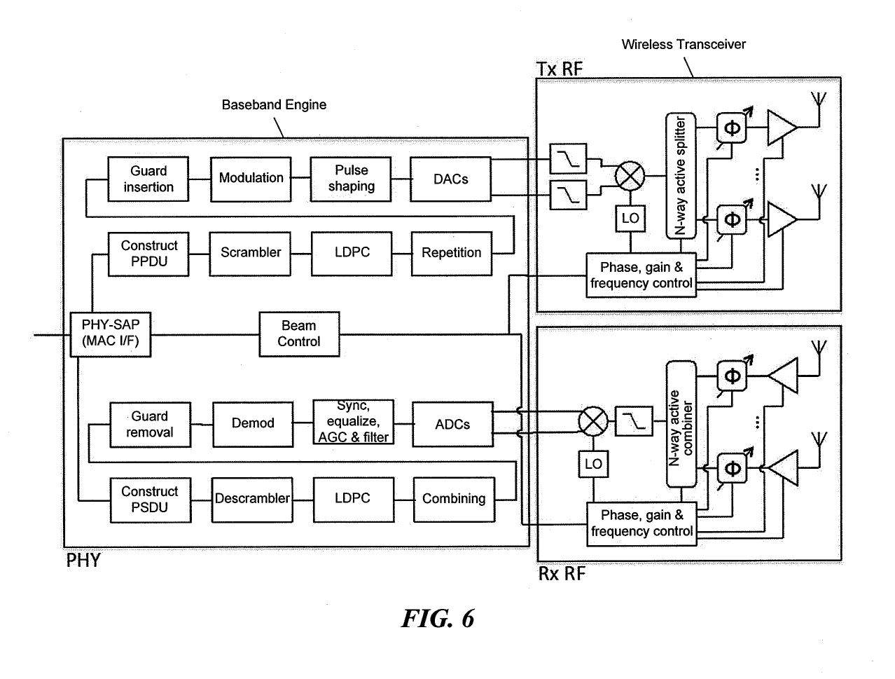

FIG. 6 shows the functional blocks of the baseband engine and radio transceiver of FIG. 1. The functional blocks of FIG. 6 are generally self-explanatory based on the detailed description provided herein. FIG. 6 shows PHY data plane (i.e. the BB processing engine) and RF layer architecture (i.e. radio transceiver) associated with a node that is implementing the single carrier physical layer IEEE 802.11 protocol. The RF architecture uses direct conversion from baseband to RF and employs phase shifting at RF. In some implementations, other approaches are used, such as a two stage superheterodyne architecture under which a signal is converted from baseband to an intermediate frequency (e.g. 15 GHz) and then to the RF frequency. The phase shifting and gain control as part of forming a beam may be performed at baseband or in the local oscillator path. This phase shift and gain control at baseband or in the local oscillator path may be either the entire shift and gain required to form a beam, or could be in part applied at the baseband or local oscillator path in addition to phase shifting and gain control at intermediate or RF stages.

Overall, the functional blocks shown in FIG. 6 are generally common among, e.g. APs, though the operation of the encoding/decoding (LDPC) block may differ by implementations. However, the module, such as the PPF, and MAC and BB engines, may generally employ off-the-shelf silicon, upon which is layered software/firmware to support for efficient multi-hop point-to-multi-point relay.

The system supports centralized operations and maintenance (OAM) and facilitates the node and architecture to be self-organizing, in the sense that the network of nodes will be a dynamic self-organizing network (SON) supporting multi-hop point-to-multipoint or multi-hop mesh topologies. To facilitate this software defined networking (SDN) approaches may be utilized, including the use of OpenFlow, such that some of the control plane functionality required to support the operation of the node in a network of nodes is provided by a centralized controller. In this architecture each node presents an application programming interface (API) to allow the centralized function to control the behavior of the node within the network of nodes.

The system described above includes several elements, combined together, to create a new type of wireless communications system (hardware and embedded software) that is able to provide low latency, Gbps communications over much longer ranges than would otherwise be possible. In addition, the approach of using centralized OAM, dynamic SON and SDN (and SDD in the case frequency division duplexing is required) enables a large network of numerous nodes to be deployed and operated with ease, and for the network to be able to self-optimize based on traffic patterns and changes in topology caused when certain wireless links become available or unavailable between any two nodes within the network.

The system can be realized using a number of system-on-chip (SoC) and system in package (SiP) devices (integrated circuits and systems) mounted on to a printed circuit board (PCB). Alternatively the various elements can be implemented on separate silicon dies and integrated into one or more SoCs or SiPs, and ultimately all the elements can be implemented on a single silicon die and packaged in a SiP.

The hardware module described above forms a basic building block that has multiple features, including: capable of being combined with access nodes either as an integral module, or as a field pluggable device, to provide metro-wide transport connectivity; capable of being packaged with one or more other modules to provide a “relay” function to allow two or more access nodes to connect; capable of being packaged with other modules to provide a “hub” function to allow nodes to connect to a fiber link to the core network; etc.

A node with multiple modules may incorporate all of the elements described on each module, or one of the modules can behave as a master module, itself driving, for example, just the PHY and/or RF element on one or more other modules.

One benefit of such a solution is that it enables a number of very low cost, high capacity simple wireless links to be provided, leveraging highly integrated and relatively low-cost electronics, but, by relying on intelligence in the software residing on the modules, enables dynamic, adaptive, low latency and resilient multi-hop point-to-multipoint or multi-hop mesh networks to be formed. As such it enables the potential to offer a much lower cost per GB solution, but also enables the easy deployment of a very resilient network.

One of ordinary skill in the relevant art will recognize that, although not required, aspects of the invention may be implemented as computer-executable instructions, such as routines executed by a general-purpose data processing device, e.g., a server computer, wireless device, personal computer, etc. Those skilled in the relevant art will appreciate that aspects of the invention can be practiced with other communications, data processing, or computer system configurations, including: Internet appliances, hand-held devices (including personal digital assistants (PDAs)), wearable computers, all manner of cellular or mobile phones (including Voice over IP (VoIP) phones), dumb terminals, media players, gaming devices, multi-processor systems, microprocessor-based or programmable consumer electronics, set-top boxes, network PCs, mini-computers, mainframe computers, and the like. Indeed, the terms “computer,” “server,” and the like are generally used interchangeably herein, and refer to any of the above devices and systems, as well as any data processor.

Aspects of the invention can be embodied in a special purpose computer or data processor that is specifically programmed, configured, or constructed to perform one or more of the computer-executable instructions explained in detail herein. While aspects of the invention, such as certain functions, are described as being performed exclusively on a single device, the invention can also be practiced in distributed environments where functions or modules are shared among disparate processing devices, which are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

The system may work with various telecommunications elements, include 2G/3G/4G network elements (including base stations, Node Bs, eNode Bs, etc.), picocells, etc. Alternatively or additionally, the network includes an IP-based network that includes, e.g., a VoIP broadcast architecture, UMA or GAN (Generic Access Network) broadcast architecture, or a femtocell broadcast architecture. (Unlicensed Mobile Access or UMA, is the commercial name of the 3GPP Generic Access Network or GAN standard). Of course, VoIP using WiFi access points (APs) or other nodes of an IEEE 802.11 network may be used.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

I/we claim:

1. A wireless communications module for communicating with a wireless device, comprising:
a packet processing function (PPF) configured to exchange communications between the wireless device and a network,
wherein the PPF is configured to exchange frames between the module and the wireless device, and
wherein the PPF is configured to communicatively couple with at least one other module at a first node;
a wireless MAC layer component, coupled to the PPF, and configured to forward frames across beamformed wireless communication links to a second node; and
a millimeter wave (30 GHz-300 GHz) physical layer and radio transceiver component coupled to the wireless MAC layer component,
wherein the physical layer and radio transceiver component includes a multi-element antenna array configured to provide the beamformed wireless links to the second node.

2. The wireless communications module of claim 1, wherein the PPF is a layer-2 switch.

3. The wireless communications module of claim 1, wherein the multi-element antenna array is further configured to operate in a bandwidth of 1 GHz or more.

4. The wireless communications module of claim 1,
wherein the wireless module is configured to operate in a first bandwidth under first conditions,
wherein the wireless module is configured to operate in a second bandwidth under second conditions,
wherein the second conditions are associated with a degradation of the beamformed wireless links between the first node and the second node, and
wherein the second bandwidth is less than the first bandwidth.

5. The wireless communications module of claim 1 wherein the wireless module is integrated in either an embedded or pluggable form at the first node to provide wireless backhaul connectivity for a host node.

6. The wireless communications module of claim 1 wherein the wireless MAC layer component is configured to provide dynamic multi-hop point-to-multipoint and/or mesh network topologies over a communication link using dynamic beam forming with directional transmissions.

7. The wireless communications module of claim 1, wherein the physical layer and radio transceiver component includes a first radio frequency integrated circuit (RFIC) coupled to a first set of antenna elements, and a second RFIC coupled to a second set of antenna elements,
wherein the first RFIC is configured to operate in a transmit mode and the second RFIC is configured to operate in a receive mode to provide the beamformed wireless links to the second node, and
wherein the second RFIC is configured to filter a signal transmitted by the first set of antenna elements from a signal received by the second set of antenna elements after the received signal has been digitized without the transmitted signal first being filtered from the received signal in an analog domain.

8. The wireless communications module of claim 7, wherein the first and second RFICs and the first and second antenna elements are configured to provide the beamformed wireless links to the second node for a self-organizing network that includes the wireless communication module.

9. The wireless communications module of claim 1,
wherein the physical layer and radio transceiver component includes:
an analog phased array beam-forming based RFIC, and
a multi-gigabit per second (Gbps) capable baseband processing element; and
wherein the wireless MAC layer component comprises a multi-Gbps beam-aware point-to-multi-point MAC processing engine.

10. The wireless communications module of claim 1,
wherein the physical layer and radio transceiver component includes at least two RFICs and a baseband engine,
wherein the at least two RFICs are configured to all operate in a transmit mode or a receive mode on a same channel at a same time, and
wherein the physical layer and radio transceiver component is configured to combine signals associated with each of the at least two RFICs either prior to or in the baseband engine.

11. The wireless communications module of claim 1,
wherein the physical layer and radio transceiver component includes at least two RFICs and a baseband engine,
wherein the at least two RFICs are configured to:
increase a gain of a signal of the beamformed wireless links to the second node by operating at least two of the RFICs in a transmit mode or a receive mode on a same channel at a same time, and
provide for a beamformed wireless link to a third node by operating at least one of the at least two RFICs in transmit mode for transmitting a signal to the second node and at least one of the at least two RFICs in receive mode for receiving a signal from the third node.

12. The wireless communications module of claim 7, wherein a quantity of antenna elements in the first set of antenna elements is greater than a quantity of transmit and/or receive chains so as to enable greater array gain.

13. The wireless communications module of claim 1,
wherein the physical layer and radio transceiver component includes a first RFIC coupled to a first set of antenna elements, and a second RFIC coupled to a second set of antenna elements,
wherein the physical layer and radio transceiver component includes a baseband processing engine,
wherein channels used for transmit and/or receive on the first RFIC and the second RFIC are defined in computer-executable instructions stored in a memory of the baseband processing engine, and
wherein a duplexing mode, including frequency division full-duplex (FDD) or time division full-duplex (TDD), is defined in computer-executable instructions stored in the memory of the baseband processing engine.

14. The wireless communications module of claim 1,
wherein the physical layer and radio transceiver component includes a RFIC coupled to a set of antenna elements,
wherein the physical layer and radio transceiver component is configured to perform software defined duplexing.

15. The wireless communications module of claim 1,
wherein the physical layer and radio transceiver component is configured to perform software defined duplexing for operation in the following modes:
a full duplex relay mode with full duplex links;
a full duplex relay with half duplex links;
a half duplex relay with full duplex links; and
a half duplex relay with half duplex links.

16. A network node for communicating with a wireless device, comprising:
a housing;
at least two wireless communications modules within the housing, wherein each wireless communications module includes:
a PPF configured to communicate with the wireless device,
wherein the PPF is configured to exchange frames between the module and the wireless device, and
wherein the PPF is configured to couple with at least one other module at the node;
a wireless MAC layer component, coupled to the PPF, and configured to forward frames across beamformed wireless communication links to another node; and
a millimeter wave (30 GHz-300 GHz) physical layer and radio transceiver component coupled to the wireless MAC layer component,
wherein the physical layer and radio transceiver component includes a multi-element antenna array configured to provide the beamformed wireless links to the other node.

17. The network node of claim 16 wherein the node communicates with at least two other nodes, wherein each node has provides a communication path between two end-points, wherein the nodes autonomously create the communication path and relay frames via one or more intermediate nodes without the need for external assistance, and wherein the nodes are able to dynamically update communication paths to adapt to changes in network topology.

18. The network node of claim 16, wherein the at least two wireless communications modules are configured to provide, in combination, functionality required at a hub, a relay station, an access point, or an end-point station.

19. An apparatus for communicating with a wireless device, comprising:
packet processing function means for exchanging packets or frames between the wireless device and a network;
MAC layer means, coupled to the packet processing function means, for forwarding frames across beamformed wireless communication links to a node; and
a millimeter wave (30 GHz-300 GHz) physical layer and radio transceiver means, coupled to the MAC layer means for providing the beamformed wireless links to the node.

20. A wireless communications module for communicating with a wireless device, comprising:
a packet processing function (PPF) configured to exchange communications between the wireless device and a network,
wherein the PPF is configured to exchange frames between the module and the wireless device, and
wherein the PPF is configured to communicatively couple with at least one other module at a first node;
a wireless MAC layer component, coupled to the PPF, and configured to forward frames across beamformed wireless communication links to a second node, and
a millimeter wave (30 GHz-300 GHz) physical layer and radio transceiver component coupled to the wireless MAC layer component,
wherein the physical layer and radio transceiver component includes a multi-element antenna array configured to provide the beamformed wireless links to the second node,
wherein the physical layer and radio transceiver component includes an RFIC that interfaces directly with the MAC layer,
wherein the physical layer and radio transceiver component includes a baseband processing engine;
wherein the wireless MAC layer is configured to drive the baseband processing engine and the RFIC concurrently based at least in part on a beam configuration specified by the MAC layer.

21. A method of controlling beamforming of an RFIC, the method performed by a processor executing instructions stored in a memory, the method comprising:
maintaining a mapping that associates antenna weight vector (AWV) identifiers (IDs) or antenna element map (AEM) IDs with nodes,
maintaining a mapping that associates AWV IDs with a phase shift and amplitude gain or AEM IDs with a vector or array element configuration parameter;
receiving an indication to create a beamformed wireless link with a node;
identifying an AWV ID or an AEM ID associated with the node based on the mapping;
identifying vector or array element configuration parameters associated with the AEM ID or a phase shift and amplitude gain associated with the AWV ID; and
configuring an antenna beam for the beamformed wireless link with the node by:
applying the vector or array element configuration parameters to an antenna element array transmitting a signal; and/or
driving the antenna element array to generate the signal modified by the phase shift and/or amplitude gain associated with the AWV ID.

22. The method of claim 21, further comprising optimizing the vector or array element configuration parameter during a beam training, refinement, and/or tracking phase.

23. The method of claim 21, wherein the vector or array element configuration parameters include parameters for each polarization of the antenna element array, wherein the method further comprises:
applying the parameters for each polarization to the antenna element array;
driving the antenna element array to employ multiple-input-multiple-output techniques to transmit the signal and receive a different signal simultaneously over multiple polarizations.
